(19) United States
(12) Patent Application Publication
(10) Pub. No.: US 2012/0326449 A1
(43) Pub. Date: Dec. 27, 2012

(54) GEARING GENERATOR FOR AN ELECTRIC VEHICLE

(76) Inventors: Ho-Yo Liao, Dacun Township (TW); Yu-Hsuan Liao, Taichung City (TW)

(21) Appl. No.: 13/169,345

(22) Filed: Jun. 27, 2011

(51) Int. Cl. H02K 7/18

(52) U.S. Cl. 290/1 C

(57) ABSTRACT

A gearing generator for an electric vehicle has a gear transmission box, a gearing device and an electromotor. The gearing device is mounted in the gear transmission box and has a transmission shaft, an output shaft and a gear-up segment. The transmission shaft is rotatably mounted through the gear transmission box. The output shaft is mounted in the gear transmission box above the transmission shaft. The gear-up segment is connected between the transmission shaft and the output shaft. The electromotor is connected to the gearing device outside the gear transmission box and has a base, a coil stator, an eccentric flywheel, a fan, a protecting hood and a commutator. The base is mounted on the gear transmission box. The coil stator is mounted on the base. The eccentric flywheel is mounted on the output shaft and has a flywheel hole, a unilateral bearing, a permanent-magnet rotor and multiple weighted blocks.

### BACKGROUND OF THE INVENTION

1. Field of the Invention

The present invention relates to a gearing generator, and more particularly to a gearing generator for an electric vehicle to improve the electricity generating efficiency of the electric vehicle and to increase the running distance of the electric vehicle to reduce the frequency of charging.

2. Description of Related Art

Batteries mounted on the conventional electric vehicles provide electric power to the conventional electric vehicles to enable the conventional electric vehicles to move. The speed of an electric motorcycle is between 20 to 40 kilometers per hours, and the speed of a power wheelchair is between 6 to 15 kilometers per hour. When the speed of the electric vehicle is 6 km/hour with a ten-inches tire, the rotating speed of a wheel axle of the electric vehicle is 125 rpm (rotation per minute). When the speed of the electric vehicle is 32 km/hour with a twenty-inches tire, the rotating speed of a wheel axle of the electric vehicle is 335 rpm (rotation per minute).

As set forth, the conventional electric vehicle has an electromotor to generate electric power to charge the battery of the conventional electric vehicle at a lower rotating speed and this only can provide a limit charging effect to the conventional electric vehicle. In addition, the electromotor is directly connected to a wheel axle of the conventional electric vehicle and cannot be inertial rotated without the wheel axle of the conventional electric vehicle. Therefore, when the rotating speed of the wheel axle is reduced, the electricity generating efficiency of the electromotor is also reduced.

A gearing generator for an electric vehicle in accordance with the present invention mitigates or obviates the aforementioned problems.

### SUMMARY OF THE INVENTION

The main objective of the invention is to provide a gearing generator for an electric vehicle to enable the electric vehicle that can improve the electricity generating efficiency of the electric vehicle and the increase the running distance of the electric vehicle to reduce the frequency of charging.

The gearing generator for an electric vehicle in accordance with the present invention has a gear transmission box, a gearing device and an electromotor. The gearing device is mounted in the gear transmission box and has a transmission shaft, an output shaft and a gear-up segment. The transmission shaft is rotatably mounted through the gear transmission box. The output shaft is mounted through an inner side of the gear transmission box above the transmission shaft. The gear-up segment is connected between the transmission shaft and the output shaft. The electromotor is connected to the gearing device outside the gear transmission box and has a base, a coil stator, an eccentric flywheel, a fan, a protecting hood and a commutator. The base is securely mounted on the gear transmission box. The coil stator is mounted on the base. The eccentric flywheel is mounted on the output shaft beside the coil stator and has a flywheel hole, a unilateral bearing, a permanent-magnet rotor and multiple weighted blocks. The fan is mounted around the output shaft and is securely connected to the eccentric flywheel. The protecting hood is mounted securely on the gear transmission box. The commutator is securely mounted on the gear transmission box, is electrically connected to the coil stator and has a leading wire.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of a gearing generator for an electric vehicle in accordance with the present invention;

FIG. 2 is an enlarged side view in partial section of the gearing generator in FIG. 1;

FIG. 3 is an operational side view in partial section of the gearing generator in FIG. 1 mounted on a power wheelchair;

FIG. 3A is an enlarged side view of a unilateral bearing of the gearing generator in FIG. 3;

FIG. 4 is an operational side view in partial section of the gearing generator in FIG. 1 mounted on an electric motorcycle; and

FIG. 4A is an enlarged side view of a unilateral bearing of the gearing generator in FIG. 4.

### DETAILED DESCRIPTION OF PREFERRED EMBODIMENT

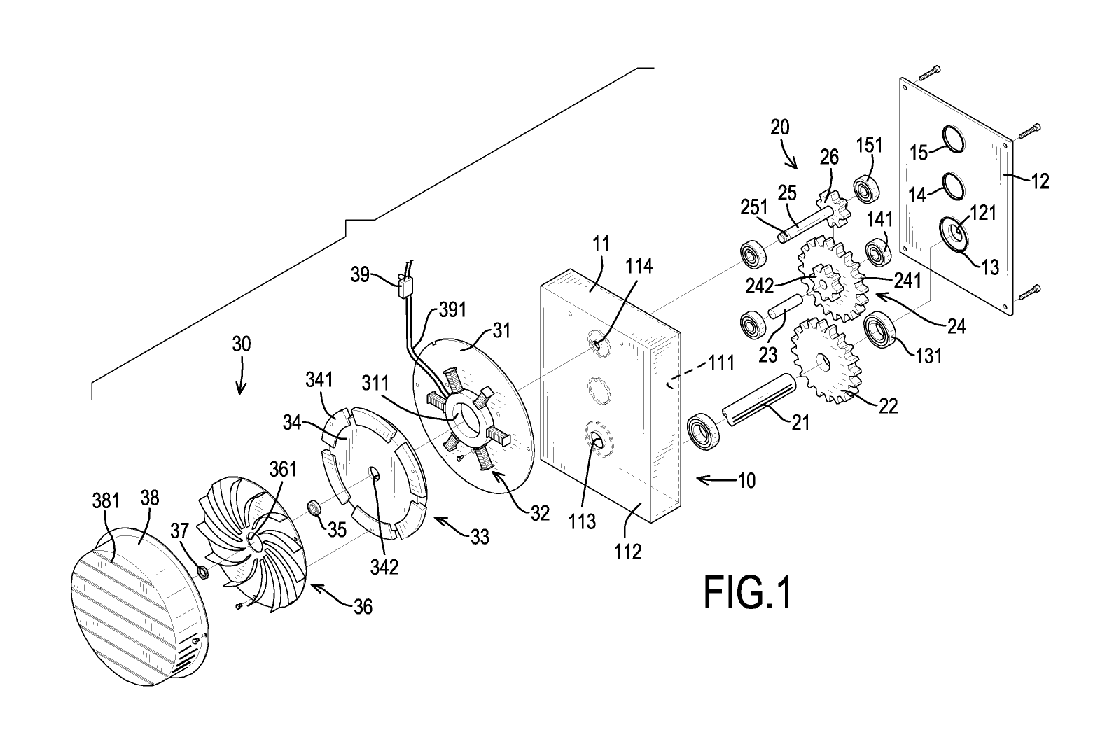

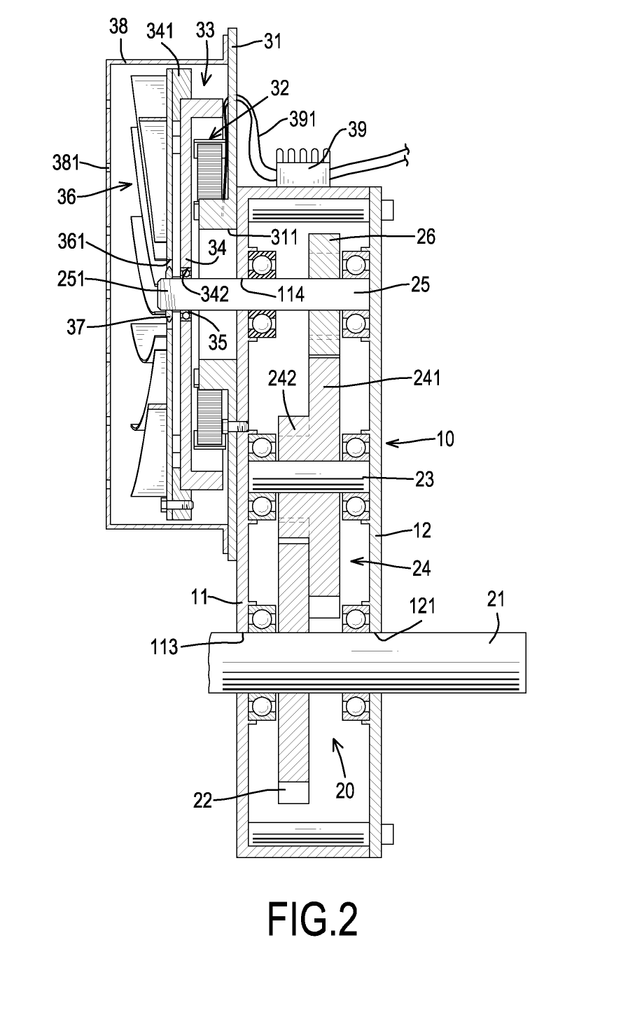

With reference to FIGS. 1 and 2, a gearing generator for an electric vehicle in accordance with the present invention comprises a gear transmission box 10, a gearing device 20 and an electromotor 30.

The gear transmission box 10 has an inner side, an outer side, a casing 11, a cover 12, two first bearing mounts 13, two second bearing mounts 14 and two third bearing mounts 15.

The casing 11 may be a rectangular casing, is formed on the inner side of the gear transmission box 10 and has an inner side, an outer side, an external surface, an opening 111, a sideboard 112, a shaft hole 113 and a through hole 114. The opening 111 is formed through the outer side of the casing 11. The sideboard 112 is defined on the inner side of the casing 11 and has a top end, a lower end and an outer side. The shaft hole 113 is formed through the sideboard 112 adjacent to the lower end of the sideboard 112. The through hole 114 is formed through the sideboard 112 adjacent to the upper end of the sideboard 112.

The cover 12 is formed on the outer side of the gear transmission box 10, is securely connected to the casing 11 with multiple fasteners to close the opening 111 and has an inner side, an outer side and a shaft hole 121. The inner side of the cover 12 faces the opening 111 of the casing 11. The shaft hole 121 is formed through the sides of the cover 12 and aligns with the shaft hole 113 of the casing 11.

The first bearing mounts 13 are respectively formed on and protrude from the outer side of the sideboard 112 and the inner side of the cover 12, are respectively mounted around the shaft holes 113, 121 of the casing 11 and the cover 12 and align with each other, and each first bearing mount 13 has a first bearing 131 mounted in the first bearing mount 13.

The second bearing mounts 14 are respectively formed on and protrude from the outer side of the sideboard 112 and the inner side of the cover 12 above the first bearing mounts 13 and align with each other, and each second bearing mount 14 has a second bearing 141 mounted in the second bearing mount 14.

The third bearing mounts 15 are respectively formed on and protrude from the outer side of the sideboard 112 and the inner side of the cover 12 above the second bearing mounts 14. One of the third bearing mounts 15 is mounted around the through hole 114 of the casing 11 and the other third bearing mount 15 aligns with the corresponding third bearing mount 15. Each third bearing mount 15 has a third bearing 151 mounted in the third bearing mount 15.

The gearing device 20 is mounted in the gear transmission box 10 and has a transmission shaft 21, an output shaft 25 and a gear-up segment.

The transmission shaft 21 is rotatably mounted through the sides of the gear transmission box 10, is mounted through the first bearings 131 of the first mounts 13, extends out of the shaft holes 113, 121 of the casing 11 and the cover 12 and has an inner end and an outer end. The inner end of the transmission shaft 21 extends out of the casing 11. The outer end of the transmission shaft 21 extends out of the cover 12. In use, the transmission shaft 21 is used as a wheel axle of an electric vehicle.

The output shaft 25 is mounted through the inner side of the gear transmission box 10 above the transmission shaft 21, is mounted between the third bearings 151 of the third bearing mounts 15 and has an inner end, an outer end, an external surface and an outer thread 251. The outer end of the output shaft 25 is mounted in the third bearing 151 that mounted on the cover 12. The inner end of the output shaft 25 extends out of the casing 11 via the through hole 114. The outer thread 251 is formed around the external surface of the output shaft 25 at the inner end of the output shaft 25.

The gear-up segment is connected between the transmission shaft 21 and the output shaft 25 and has a transmission gear wheel 22, a central shaft 23, a connecting gear disk 24 and an output gear wheel 26.

The transmission gear wheel 22 is securely mounted around the transmission shaft 21 in the gear transmission box 10 between the casing 11 and the cover 12 and has a diameter and multiple teeth. The central shaft 23 is mounted between the second bearings 141 of the second bearing mounts between the transmission shaft 21 and the output shaft 25.

The connecting gear disk 24 is securely mounted around the central shaft 23 between the casing 11 and the cover 12 of the gear transmission box 10 and has an outer side, an inner side, a major gear segment 241 and a minor gear segment 242. The out side of the connecting gear disk 24 faces the cover 12. The inner side of the connecting gear disk 24 faces the casing 11. The major gear segment 241 is formed on the outer side of the connecting gear disk 24 and has a diameter and multiple teeth. The minor gear segment 242 is formed on the inner side of the connecting gear disk 24, is formed with the major gear segment 241 and has a diameter smaller than the diameter of the major gear segment 241. The minor gear segment 242 engages the transmission gear wheel 22 to enable the central shaft 23 to rotate with the transmission shaft 21.

The output gear wheel 26 is securely mounted around the output shaft 25 between the casing 11 and the cover 12 of the gear transmission box 10, engages the major gear segment 241 of the connecting gear disk 24 to enable the output shaft 25 to rotate with the transmission shaft 21 via the connecting gear disk 24, the central shaft 23 and the output gear wheel 26 and has a diameter and multiple teeth. The diameter of the out gear wheel 26 is smaller than the diameters of the transmission gear wheel 22 and the major gear segment 241 of the connecting gear disk 24. The teeth of the out gear wheel 26 are lesser than the teeth of the transmission gear wheel 22 and the major gear segment 241 of the connecting gear disk 24.

The electromotor 30 is connected to the gearing device 20 outside the gear transmission box 10 and has a base 31, a coil stator 32, an eccentric flywheel 34, a fan 36, a screw nut 37, a protecting hood 38 and a commutator 39.

The base 31 is securely mounted on the inner side of the gear transmission box 10, is securely mounted on the sideboard 112 of the casing 11 by fasteners and has a center, an inner side and a base hole 311. The base hole 311 is formed through the center of the base 31 and aligns with and communicates with the through hole 114 of the casing 11. The inner end of the output shaft 25 extends out of the base hole 311 of the base 31. The coil stator 32 is mounted on the inner side of the base 31 opposite to the casing 11 around the base hole 311 of the base 31.

The eccentric flywheel 34 is mounted on the output shaft 25 beside the coil stator 32 and has an inner side, an outer side, a periphery, a center, a flywheel hole 321, a unilateral bearing 35, a permanent-magnet rotor 33 and multiple weighted blocks 341. The outer side of the eccentric flywheel 34 faces the coil stator 32. The flywheel hole 342 is formed through the center of the eccentric flywheel 34 and is mounted around the output shaft 25. The unilateral bearing 35 is mounted in the flywheel hole 342 and is mounted around the output shaft 25. The permanent-magnet rotor 33 is annular and is mounted on and protrudes form the outer side of the eccentric flywheel 34 around the coil stator 32. The weighted blocks 341 are mounted on the inner side of the eccentric flywheel 34 at intervals around the periphery of the eccentric flywheel 34.

The fan 36 is mounted around the output shaft 25, is securely connected to the eccentric flywheel 34 to rotate with the eccentric flywheel 34 and abuts the weighted blocks 341 and has an inner side, an outer side, a center and a fan hole 361. The outer side of the fan 36 securely abuts with the weighted blocks 341 by the fan 36 securely connected to the eccentric flywheel 34. The fan hole 361 is formed through the center of the fan 36 and is mounted around the output shaft 25.

The screw nut 37 is mounted in the fan hole 361 of the fan 36 and is screwed with the outer thread 251 of the outer shaft 25 to prevent the unilateral bearing 35 from escaping out of the output shaft 25. The protecting hood 38 is mounted securely on the inner side of the base 31 by fasteners and is mounted around the coil stator 32, the eccentric flywheel 34 and the fan 36 and has an inner side and multiple eliminating holes 381. The eliminating holes 381 are elongated and are formed through the inner side of the protecting hood 38 at intervals to eliminate heat generated between the casing 11 and the protecting hood 38.

The commutator 39 is securely mounted on the external surface of the casing 11 of the gear transmission box 10, is electrically connected to the coil stator 32 to transform an alternating current formed by the electromagnetic effect between the coil stator 32 and the permanent-magnet rotor 33 into a direct current and has a leading wire 391. The leading wire 391 is electrically connected to the coil stator 32 to transport the alternating current into the commutator 39.

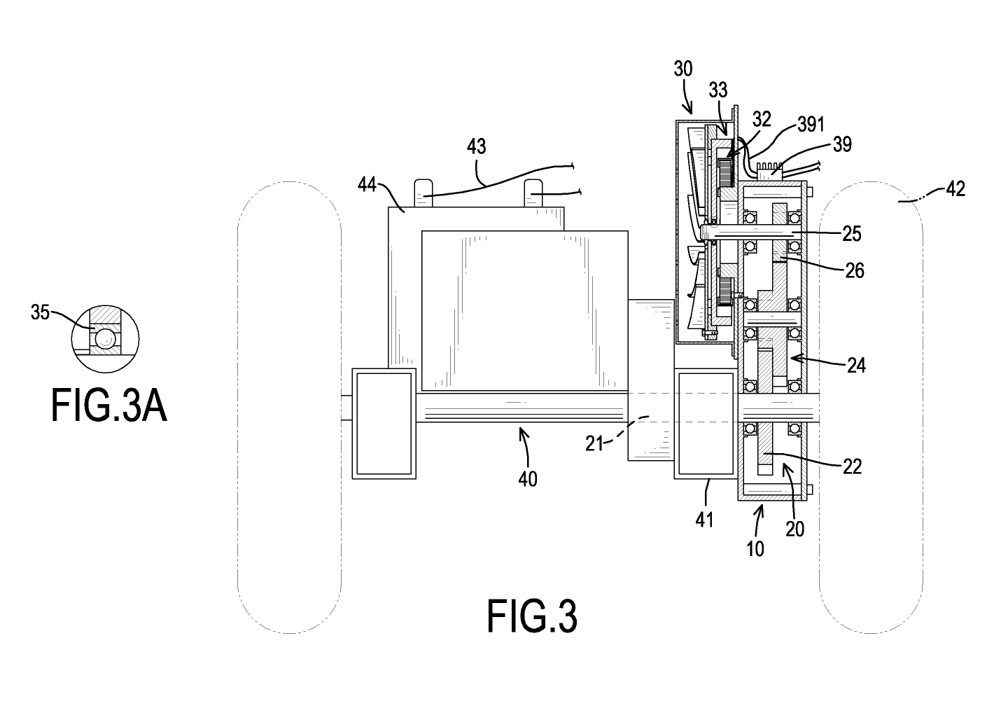

In operation, with reference to FIG. 3, when using the gearing generator in accordance with the present invention in a power wheelchair 40 having a body 41, a wheel axle, two tires 42 and a battery 44, the transmission shaft 21 of the gearing device 20 of the present invention is used as the wheel axle of the power wheel chair 40 and is rotatably connected to the body 41 of the power wheelchair 40. The tires 42 are respectively connected to the ends of the transmission shaft 21. The battery 44 is mounted on the power wheelchair 40 beside the body 41 and has a conducting wire 43. Then, the gear transmission box 10 and the gearing device 20 are mounted around the transmission shaft 21 between the body 41 and one of the tires 42. The commutator 39 is securely mounted on the gear transmission box 10 and is electrically connected to the conducting wire 43 of the battery 44.

When the power wheelchair 40 is moving, the transmission shaft 21 will be rotated with the power wheelchair 40 and the output shaft 25 will also be rotated by the transmission of the transmission gear wheel 22, the connecting gear disk 24 and the output gear wheel 26 of the gear-up segment at a higher speed than that of the transmission shaft 21 due to the different diameters and teeth of the gear wheels 22, 26 and the connecting gear disk 24. Then, the permanent-magnet rotor 33 is rotated with the output shaft 25 via the unilateral bearing 35 relative to the coil stator 32 to generate an alternating current by the electromagnetic effect between the coil stator 32 and the permanent-magnet rotor 33. The alternating current will be transported to and transformed into a direct current by the commutator 39 via the leading wire 391. Then, the direct current will be led to the battery 44 via the conducting wire to provide a charging effect to the power wheelchair 40.

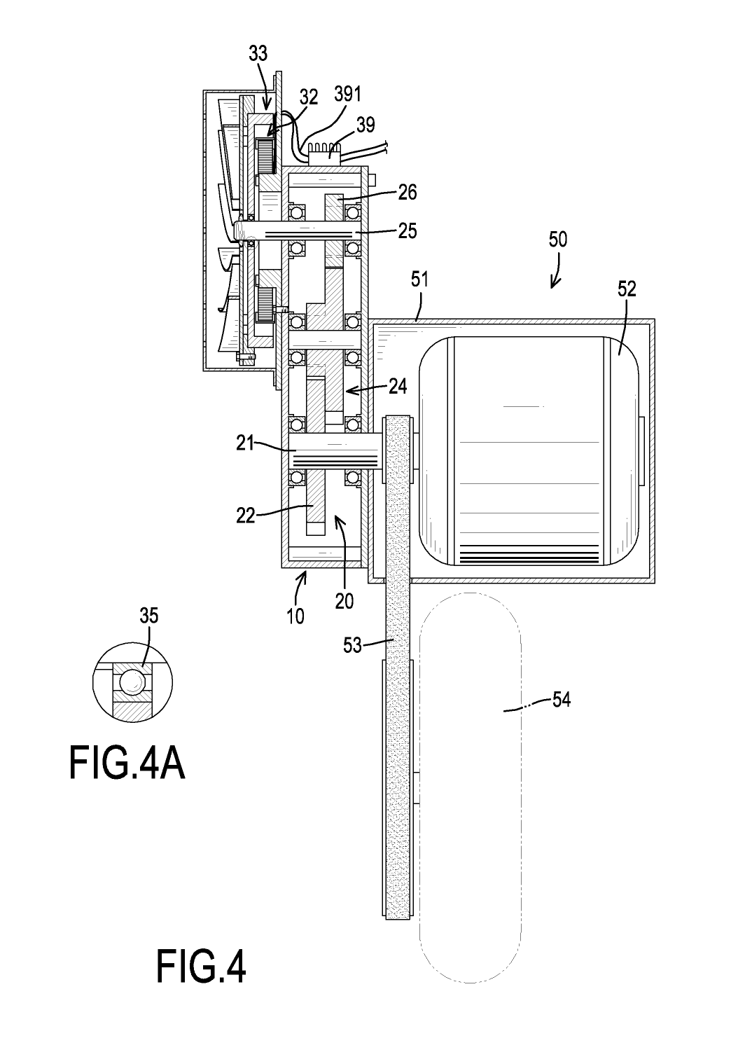

Furthermore, with reference to FIG. 4, when using the gearing generator in accordance with the present invention in an electric motorcycle 50 having a body 51, a motor 52, a belt 53, a wheel axle and a tire 54. The motor 52 is mounted in the body 51 and has a motor shaft. The belt 53 is mounted around the motor shaft of the motor 52. The wheel axle of the electric motorcycle 50 is connected to the belt 53 below the body 51. The tire 54 is connected to the wheel axle of the electric motorcycle 50. The gear transmission box 10 is securely connected to the body 51 of the electric motorcycle 50 and the transmission shaft 21 of the gearing device 20 is used as the motor shaft of the motor 52 of the electric motorcycle 50.

When the electric motorcycle 50 is moved by the transmission shaft 21 (the motor shaft) of the motor 52, the output shaft 25 will also be rotated with the transmission of the transmission gear wheel 22, the connecting gear disk 24 and the output gear wheel 26 of the gear-up segment at a higher rotating speed due to the different diameters and teeth of the gear wheels 22, 26 and the connecting gear disk 24. Then, the permanent-magnet rotor 33 is rotated with the output shaft 25 via the unilateral bearing 35 relative to the coil stator 32 to generate an alternating current by the electromagnetic effect between the coil stator 32 and the permanent-magnet rotor 33. The alternating current will be transported to and transformed into a direct current by the commutator 39 via the leading wire 391. Then, the direct current will be led to charge the electric motorcycle 50.

With further reference to FIGS. 1 and 2, the rotating speed of the output shaft 25 can be increased by the different diameters and teeth of the gear wheels 22, 26 and the connecting gear disk 24 as 14 times of the rotating speed of the transmission shaft 21. For example, if the rotating speed of the transmission shaft 21 is 125 to 335 rpm, the rotating speed of the output shaft 25 can be increased to 1500 to 4000 by the gear-up segment of the gearing device 20 to rotate the permanent-magnet rotor 33 to generate an alternating current. If the output voltage is 14 volts, the current is 1.05 ampere when the rotating speed of the output shaft 25 is 1000 rpm and will generate the electric power of 14.7 watts. Furthermore, when the rotating speed of the output shaft 25 is 4000 rpm, the current is 8.55 ampere and will generate the electric power of 120 watts. If the horsepower and the carrying capacity of the electric motorcycle 50 are respectively 750 watts and 138 kilograms, the power consumption of the electric motorcycle 50 is 10.6 watts per kilometer when the speed of the electric motorcycle is 32 km/hour. Under the speed above-mentioned, the rotating speed of the permanent-magnet rotor 33 can be reached 4000 rpm and the electromotor 30 can generate the current of 8.22 ampere and the electric power of 120 watts and this can be used to charge the battery of the electric motorcycle 50 to increase the moving distance of the electric motorcycle 50.

When the electric vehicle is assembled with the gearing generator in accordance with the present invention, the transmission shaft 21 still rotates with the electric vehicle to enable the output 25 to output power via the gearing segment even the electric vehicle moves at a downhill path or a flat road and the motor of the electric vehicle is not work. Although the accelerated velocity of the electric vehicle and the rotating-electric vehicle of the transmission shaft 21 are reduced at the above-mentioned condition and the rotating speed of the output shaft 25 is lower than the inertial rotating speed of the eccentric flywheel 34, the inertial rotation of the eccentric flywheel 34 will not be limited by the output shaft 25 and the eccentric flywheel 34 will rotate inertia relative to the output shaft 25 by the unilateral bearing 35 and the weighted blocks 341 to enable the permanent-magnet rotor 33 to rotate relative to the coil stator 32 to generate electric power. Therefore, the permanent-magnet rotor 33 can be rotated with the eccentric flywheel 34 to generate electric power when the rotating speeds of the transmission shaft 21 and the output shaft 25 are reduced and this can increase the electricity generating efficiency of the electric vehicle to increase the running distance of the electric vehicle and to reduce the frequency of charging.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A gearing generator for an electric vehicle having a wheel axle and the gearing generator comprising:
a gear transmission box having an inner side and an outer side;
a gearing device mounted in the gear transmission box and having
a transmission shaft rotatably mounted through the sides of the gear transmission box and being adapted to use as the wheel axle of the electric vehicle;
an output shaft mounted through the gear transmission box above the transmission shaft and having an inner end extending out of the inner side of the gear transmission box;
a gear-up segment connected between the transmission shaft and the output shaft; and
an electromotor connected to the gearing device outside the gear transmission box and having
a base securely mounted on the inner side of the gear transmission box and having
a center;
an inner side; and
a base hole formed through the center of the base to enable the inner end of the output shaft to extend out of the base;
a coil stator mounted on the inner side of the base opposite to the gear transmission box around the base hole of the base;
an eccentric flywheel mounted on the output shaft beside the coil stator and having
an outer side facing the coil stator;
an outer side;
a periphery;
a center;
a flywheel hole formed through the center of the eccentric flywheel and mounted around the output shaft;
a unilateral bearing mounted in the flywheel hole and mounted around the output shaft;
a permanent-magnet rotor being annular and mounted on and protruding form the outer side of the eccentric flywheel around the coil stator; and
multiple weighted blocks mounted on the inner side of the eccentric flywheel at intervals around the periphery of the eccentric flywheel;
a fan mounted around the output shaft, securely connected to the eccentric flywheel to rotate with the eccentric flywheel and abutting the weighted blocks and having
an inner side securely abutting with the weighted blocks by the fan securely connected to the eccentric flywheel; and
an outer side;
a protecting hood mounted securely on the inner side of the base by fasteners, mounted around the coil stator, the eccentric flywheel and the fan and having
an inner side; and
multiple eliminating holes being elongated and formed through the inner side of the protecting hood at intervals; and
a commutator securely mounted on the gear transmission box, electrically connected to the coil stator to transform an alternating current formed by the electromagnetic effect between the coil stator and the permanent-magnet rotor into a direct current and has a leading wire electrically connected to the coil stator to transport the alternating current into the commutator.

2. The gearing generator for an electric vehicle as claimed in claim 1, wherein
the gear transmission box has
a casing being a rectangular casing, formed on the inner side of the gear transmission box and having
an inner side;
an outer side;
an external surface;
an opening formed through the outer side of the casing;
a sideboard defined on the inner side of the casing and having a top end, a lower end and an outer side;
a shaft hole formed through the sideboard adjacent to the lower end of the sideboard; and
a through hole formed through the sideboard adjacent to the upper end of the sideboard;
a cover formed on the outer side of the gear transmission box, securely connected to the casing to close the opening with multiple fasteners and having
an inner side facing the opening of the casing;
an outer side; and
a shaft hole formed through the sides of the cover and aligning with the shaft hole of the casing;
two first bearing mounts respectively formed on and protruding from the outer side of the sideboard and the inner side of the cover, respectively mounted around the shaft holes of the casing and the cover and aligning with each other and each first bearing mount having a first bearing mounted in the first bearing mount;
two second bearing mounts respectively formed on and protruding from the out side of the sideboard and the inner side of the cover above the first bearing mounts and aligning with each other and each second bearing mount having a second bearing mounted in the second bearing mount; and
two third bearing mounts respectively formed on and protrude from the outer side of the sideboard and the inner side of the cover above the second bearing mounts, one of the third bearing mounts mounted around the through hole of the casing and the other third bearing mount aligning with the corresponding third bearing mount and each third bearing mount having a third bearing mounted in the third bearing mount;
the transmission shaft is mounted through the first bearings of the first mounts, extends out of the shaft holes of the casing and the cover and has
an inner end extending out of the casing; and
an outer end extends out of the cover;
the output shaft is mounted between the third bearings of the third bearing mounts and has
an outer end mounted in the third bearing that mounted on the cover; and
an inner end extending out of the casing via the through hole;
the gear-up segment has
a transmission gear wheel securely mounted around the transmission shaft in the gear transmission box between the casing and the cover and having
a diameter; and
multiple teeth;
a central shaft mounted between the second bearings of the second bearing mounts between the transmission shaft and the output shaft;
a connecting gear disk securely mounted around the central shaft between the casing and the cover of the gear transmission box and having
an outer side facing the cover;
an inner side facing the casing;
a major gear segment formed on the outer side of the connecting gear disk and having a diameter and multiple teeth; and
a minor gear segment formed on the inner side of the connecting gear disk, formed with the major gear segment and engaging the transmission gear wheel to enable the central shaft to rotate with the transmission shaft and having a diameter smaller than the diameter of the major gear segment; and
an output gear wheel securely mounted around the output shaft between the casing and the cover of the gear transmission box, engaging the major gear segment of the connecting gear disk to enable the output shaft to rotate with the transmission shaft via the connecting gear disk, the central shaft and the output gear wheel and having
a diameter being smaller than the diameters of the transmission gear wheel and the major gear segment of the connecting gear disk; and
multiple teeth being lesser than the teeth of the transmission gear wheel and the major gear segment of the connecting gear disk;
the base is securely mounted on the sideboard of the casing by fasteners;
the base hole aligns with and communicates with the through hole of the casing; and
the commutator is securely mounted on the external surface of the casing.

3. The gearing generator for an electric vehicle as claimed in claim 2, wherein
the output shaft has an external surface and an outer thread formed around the external surface of the output shaft at the inner end of the output shaft;
the fan has a center and a fan hole formed through the center of the fan and mounted around the output shaft; and
the electromotor has a screw nut mounted in the fan hole of the fan and screwed with the outer thread of the outer shaft to prevent the unilateral bearing from escaping out of the output shaft.

4. The gearing generator for an electric vehicle as claimed in claim 1, wherein
the output shaft has an external surface and an outer thread formed around the external surface of the output shaft at the inner end of the output shaft;
the fan has a center and a fan hole formed through the center of the fan and mounted around the output shaft; and
the electromotor has a screw nut mounted in the fan hole of the fan and screwed with the outer thread of the outer shaft to prevent the unilateral bearing from escaping out of the output shaft.
